(19) United States
(12) Patent Application Publication
(10) Pub. No.: US 2026/0290053 A1
(43) Pub. Date: Sep. 24, 2026

(54) APPARATUS AND METHOD FOR PROVIDING CONVERSATION-BASED VISUAL KNOWLEDGE SERVICE USING IMAGE EDITING

(71) Applicant: ELECTRONICS AND TELECOMMUNICATIONS RESEARCH INSTITUTE, Daejeon (KR)

(72) Inventors: Jin SEONG, Daejeon (KR); Soo-Jong LIM, Daejeon (KR)

(21) Appl. No.: 19/453,703

(22) Filed: Jan. 20, 2026

(30) Foreign Application Priority Data
Mar. 19, 2025 (KR) 10-2025-0035461

(51) Int. Cl. G06V 20/70; G06T 5/70; G06T 11/60

(52) U.S. Cl. CPC G06V 20/70; G06T 5/70; G06T 11/60; G06T 2207/20182

(57) ABSTRACT

Disclosed herein is an apparatus and method for providing a conversation-based visual knowledge service using image editing. The method may include receiving a user question and an image through a user prompt, understanding the context of the question based on a conversation history of the user, and generating a response to the user question by adding an annotation to the input image based on the understood context of the question.

### CROSS REFERENCE TO RELATED APPLICATION

This application claims the benefit of Korean Patent Application No. 10-2025-0035461, filed Mar. 19, 2025, which is hereby incorporated by reference in its entirety into this application.

### BACKGROUND OF THE INVENTION

### 1. Technical Field

The disclosed embodiment relates to technology for providing a conversation-based visual knowledge service that helps visually understanding and interpreting complex concepts and data.

### 2. Description of Related Art

Existing image editing and conversational language models are used to provide information and interaction in various professional fields, such as education, healthcare, counseling, sales, and the like, but these technologies often have limitations in adequately responding to specific and dynamic needs of users.

Particularly, existing image editing techniques, for example, ‘InstructPix2Pix’, can generate or modify images based on the natural language input from a user, but they are not suitable for visual modification and addition of accurate data or concepts required in educational contexts. This implies that it is difficult to quickly respond to specific questions or problems that occur during a learning process. Also, ‘prompt-to-prompt’ technology provides the capability to modify original images, but it fails to adequately respond to real-time interaction and dynamic requirements.

Conversational language models, for example, ‘ChatGPT’ or ‘Bard’, have the capability to provide information and conduct a conversation through interaction with users, but these models focus on text-based interaction and have limitations in directly modifying visual elements or providing visual explanations specific to learning problems.

### SUMMARY OF THE INVENTION

An object of the disclosed embodiment is to enable graphs, figures, images, and the like to be immediately modified or added according to the requirements of users, thereby supporting professionals in visually and easily explaining information required in their field.

Another object of the disclosed embodiment is to provide information tailored to the requirements of individual users by enabling dynamic modification of images and incorporation of additional explanations in response to user’s questions.

A further object of the disclosed embodiment is to enhance the capability to better understand problems or situations presented by learners, patients, and customers and to derive appropriate solutions.

Yet another object of the disclosed embodiment is to significantly improve communication and information delivery methods in various fields such as education, healthcare, and commerce, to more effectively convey professional knowledge, and to maximize users’ visual understanding.

A method for providing a conversation-based visual knowledge service using image editing according to an embodiment may include receiving a user question and an image through a user prompt, understanding context of the question based on a conversation history of the user, and generating a response to the user question by adding an annotation to the input image based on the understood context of the question.

Here, understanding the context of the question may include encoding and vectorizing each of the user question and the image, integrating a user question vector and an image vector to align multimodal features representing relevance between the user question and the image, and understanding the context of the user question based on the multimodal features and the conversation history with the user.

Here, the conversation history may be previously stored in conversation history database that stores conversation records with the user in chronological order.

Here, generating the response may include determining whether it is necessary to add an annotation to the input image based on the understood context of the query; and when it is necessary to add an annotation to the image, performing image editing to add a required annotation to the user image.

Here, performing the image editing may include encoding the image input from the user from a pixel space into a latent vector, artificially adding noise to the latent vector, adding the annotation to the image while removing the noise from the image, and decoding the latent vector into an image in the pixel space.

Here, performing the image editing may further include encoding a text annotation based on the conversation history with the user, and adding the annotation may comprise adding an annotation corresponding to the text annotation to the image.

An apparatus for providing a conversation-based visual knowledge service using image editing according to an embodiment includes memory in which at least one program is recorded and a processor for executing the program, and when a user question and an image are input through a user prompt, the program may understand context of the question based on a conversation history of the user and generate a response to the user question by adding an annotation to the input image based on the understood context of the question.

Here, when understanding the context of the question, the program may encode and vectorize each of the user question and the image, integrate a user question vector and an image vector to align multimodal features representing relevance between the user question and the image, and understand the context of the user question based on the multimodal features and the conversation history with the user.

Here, the conversation history may be previously stored in conversation history database that stores conversation records with the user in chronological order.

Here, when generating the response, the program may determine whether it is necessary to add an annotation to the input image based on the understood context of the question; and when it is necessary to add an annotation to the image, the program may perform image editing to add a required annotation to the user image.

Here, when performing the image editing, the program may encode the image input from the user from a pixel space into a latent vector, artificially add noise to an image vector, generate an annotation while removing the noise from the image, and decode the latent vector into an image in the pixel space.

Here, when performing the image editing, the program may encode a text annotation based on the conversation history with the user and add an annotation corresponding to the text annotation to the image.

A method for providing a conversation-based visual knowledge service using image editing according to an embodiment may include receiving a user question and an image through a user prompt, understanding context of the question based on a conversation history of the user, determining whether it is necessary to add an annotation to the input image based on the understood context of the question, performing, when it is necessary to add an annotation to the image, image editing to add a required annotation to the user image, and generating a response to the user question by including the edited image.

Here, understanding the context of the question may include encoding and vectorizing each of the user question and the image, integrating a user question vector and an image vector to align multimodal features representing relevance between the user question and the image, and understanding the context of the user question based on the multimodal features and the conversation history with the user.

Here, the conversation history may be previously stored in conversation history database that stores conversation records with the user in chronological order.

Here, performing the image editing may include encoding the image input from the user from a pixel space into a latent vector, artificially adding noise to the latent vector, generating an annotation while removing the noise from the image, and decoding the latent vector into an image in the pixel space.

Here, performing the image editing may further include encoding a text annotation based on the conversation history with the user, and adding the annotation may comprise adding an annotation corresponding to the text annotation to the image.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a block diagram of a system for providing a conversation-based visual knowledge service using image editing according to an embodiment;

FIG. 2 is a view for explaining in detail data flow in a user interface according to an embodiment;

FIG. 3 is a schematic block diagram of an apparatus for providing a conversation-based visual knowledge service using image editing according to an embodiment;

FIG. 4 is a schematic block diagram of an apparatus for providing a conversation-based visual knowledge service using image editing according to another embodiment;

FIG. 5 is a flowchart for explaining a method for providing a conversation-based visual knowledge service using image editing according to an embodiment;

FIG. 6 is an exemplary view of conversation history database according to an embodiment;

FIG. 7 is a flowchart for explaining in detail performing image editing according to an embodiment;

FIG. 8 is an internal block diagram of an image editor according to an embodiment;

FIG. 9 is an exemplary view illustrating application of an embodiment to the field of mathematics tutoring;

FIG. 10 is a flowchart for explaining in detail a method of training an image editor according to an embodiment; and

FIG. 11 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

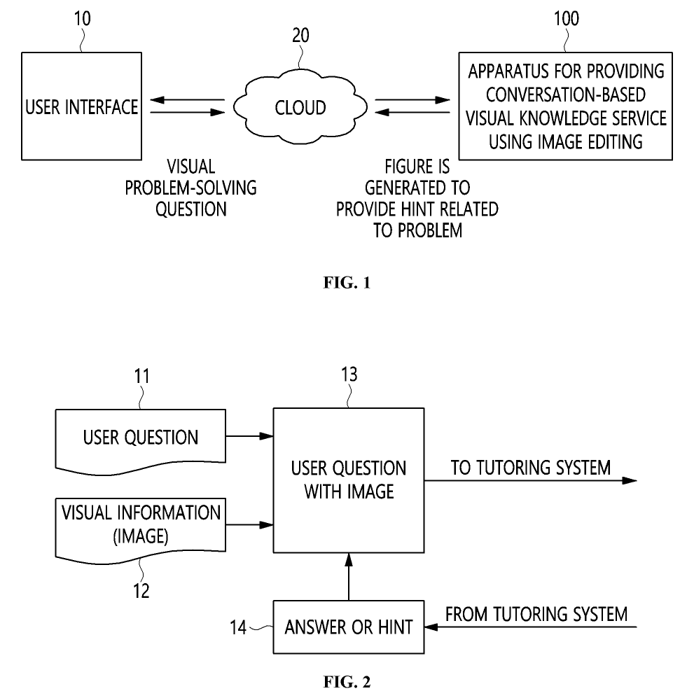

FIG. 1 is a block diagram of a system for providing a conversation-based visual knowledge service using image editing according to an embodiment.

Referring to FIG. 1, the system for providing a conversation-based visual knowledge service using image editing according to an embodiment may include a user interface 10, a cloud 20, and an apparatus 100 for providing a conversation-based visual knowledge service using image editing (referred to as an ‘apparatus’ hereinafter).

The user interface 10 may be an application that provides knowledge to a user based on conversations, and the application may be installed in an electronic device including a mobile phone, a PC, or a tablet through which the user can access the cloud 20.

The user interface 10 delivers a visual question entered by the user to the apparatus 100 via the cloud 20.

Here, according to an embodiment, the user may ask an additional question about a specific problem or request modification of visual materials through the user interface 10.

The apparatus 100 generates instructional guidance for the corresponding problem and transmits the result to the user interface 10 via the cloud 20.

Here, according to an embodiment, the apparatus 100 may directly transform an existing image immediately in response to the user’s real-time question or request for modification of visual materials and may deliver the transformed image to the user interface 10.

That is, the apparatus 100 provides a function of answering a question about a specific part of a problem while modifying or highlighting related visual materials in combination with a user question and answer.

For example, as in the case in which a mathematics teacher visually interprets a complex geometry problem and explains it to students, the apparatus 100 may dynamically modify or highlight appropriate figures or graphs in response to a student’s question about the corresponding problem.

Accordingly, the apparatus 100 supports users in more deeply and easily understanding complex information, such as scientific concepts or mathematical problems, in a visual manner, thereby encouraging active participation in a learning process, maximizing educational effectiveness, and improving the problem-solving skills of the users.

That is, in an embodiment, the apparatus 100 that plays a role of an educator aims to enhance a personalized learning experience in an educational process and improve the quality of interaction with a generative model by sensitively responding to the needs of a learner.

Hereinafter, an embodiment mainly applied to a mathematics education environment will be described. However, this is merely an example to help understanding of the description, and the present disclosure is not limitedly applied to the mathematics education environment. That is, in the present disclosure, users may include professionals in various fields, such as teachers, doctors, counselors, salespersons, and the like, as well as students, patients, and customers, and the present disclosure may be applied in various situations in which they are engaged.

FIG. 2 is a view for explaining in detail data flow in a user interface according to an embodiment.

Referring to FIG. 2, the user interface 10 according to an embodiment is designed to enable a user to ask questions about mathematics or science problems and receive solutions thereto.

A user question 11 may be a question in various forms, such as text, voice, and gesture, input by the user. For example, the user question 11 may be a textual prompt, and the textual prompt may include a description of a problem or a specific request. In addition, when the user question 11 is provided in a voice form, the user question 11 may be converted into text through a voice recognition process.

Visual information 12 may be an image uploaded by the user to supplement explanations and questions related to the input question. For example, the image may be a figure, a graph, or a related photograph associated with the problem.

A user question with an image 13 is a user question configured by combining the input textual prompt 11 and the visual information 12 and is transmitted to the apparatus 100. The user question with an image 13 may be essential information for the apparatus 100 to accurately understand the question of the user and provide an appropriate answer.

An answer or hint 14 may be delivered to the user as a response delivered from the apparatus 100. This may include an answer to the problem or a hint for solving the problem, thereby assisting the user in understanding the problem and solving the question independently.

As described above, the user interface 10 is designed to support interaction particularly in an educational context and to enable the user to clearly present a problem to the apparatus 100 and receive appropriate support from the apparatus 100, thereby maximizing educational effectiveness.

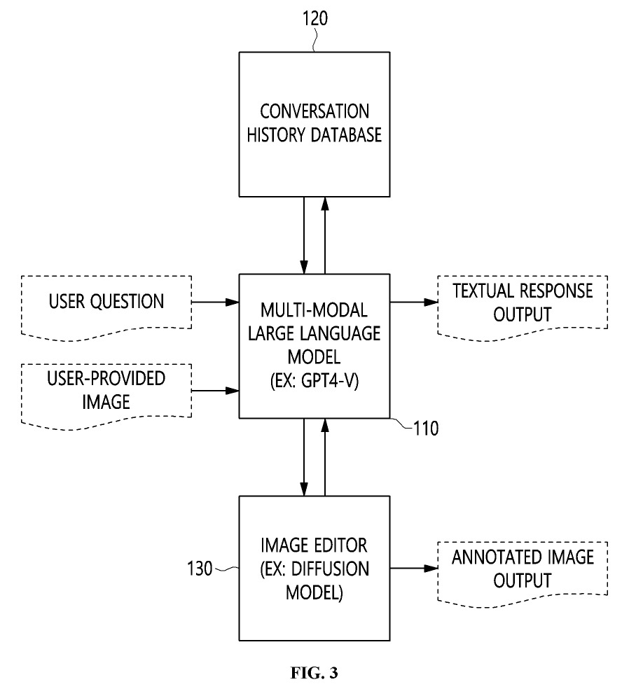

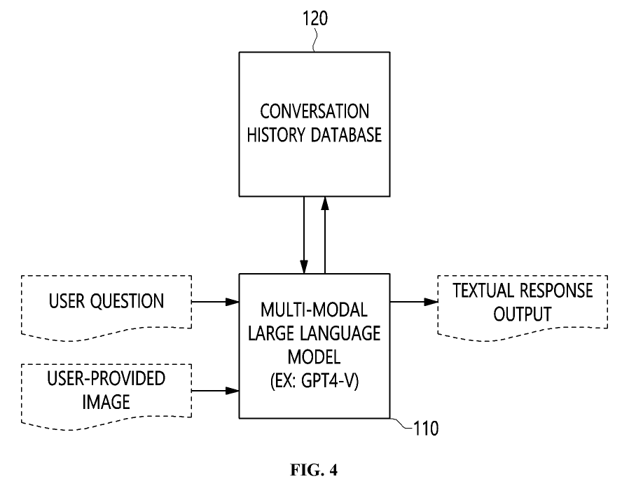

FIG. 3 is a schematic block diagram of an apparatus for providing a conversation-based visual knowledge service using image editing according to an embodiment.

Referring to FIG. 3, the apparatus 100 for providing a conversation-based visual knowledge service using image editing according to an embodiment may include a multimodal large language model 110, conversation history database 120, and an image editor 130.

The multimodal large language model 110 receives a user question and a user-provided image, which is an image uploaded by the user to supplement a description of a problem, and provides textual response output to the user.

Here, the multimodal large language model 110 may be, for example, GPT4-V.

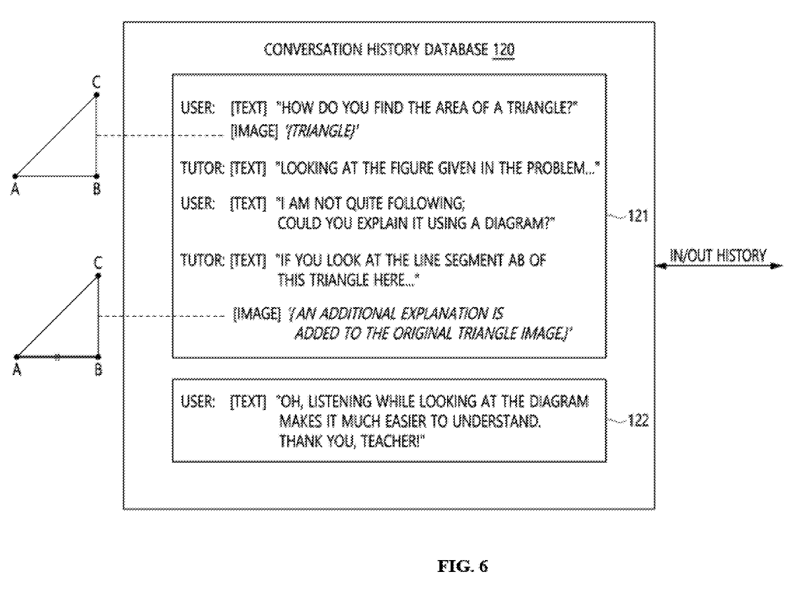

The conversation history database 120 stores conversation records of the user and is used to understand the context of a new question and generate an answer. The conversation history database 120 will be described in detail later with reference to FIG. 6.

Accordingly, the multimodal large language model 110 integrates a user question, an image, and conversation records to understand the context of a problem and generate an appropriate text answer.

The image editor 130 provides annotated image output by adding an annotation to an image provided to assist the user’s understanding or by performing image editing required for explanation.

Here, the image editor 130 may be, for example, a diffusion model.

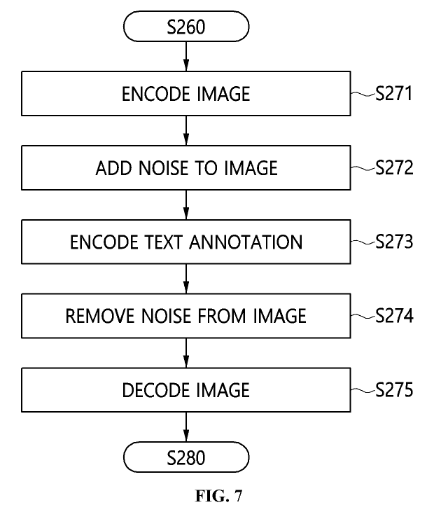

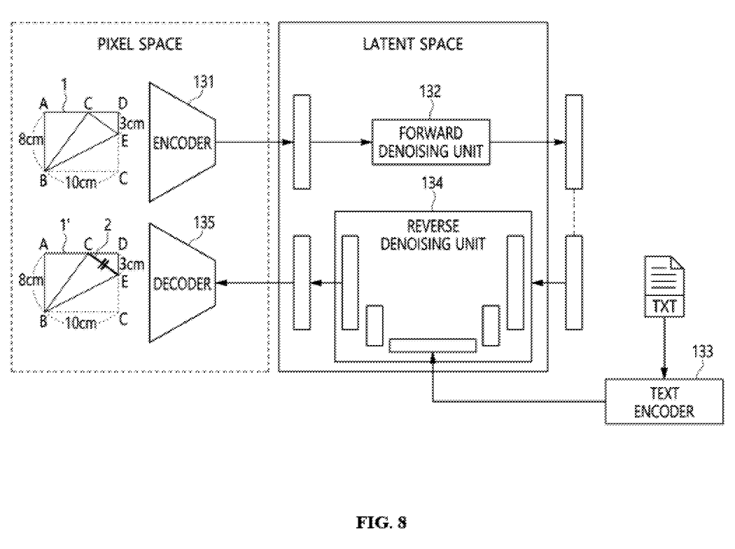

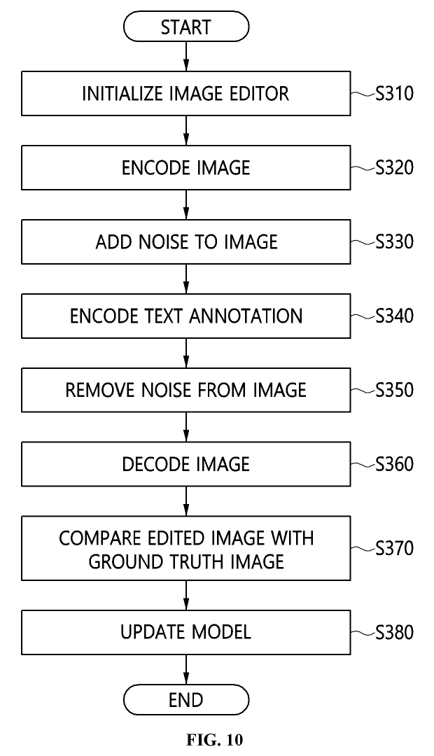

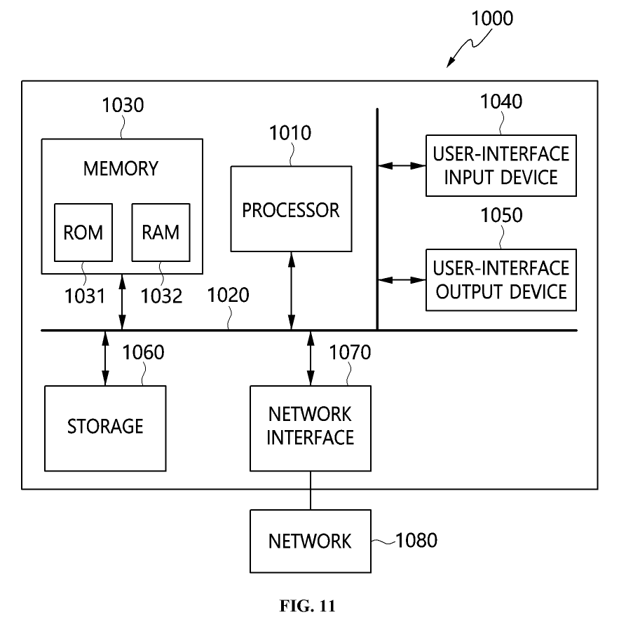

The detailed operation and configuration of the image editor 130 will be described later with reference to FIGS. 7 and 8. Also, the image editor 130 is pretrained, and the method of training the image editor 130 will be described in detail later with reference to FIG. 10.

As described above, the apparatus 100 for providing a conversation-based visual knowledge service using image editing according to an embodiment is designed to improve a user’s problem-solving skill in an educational context and provides visual and text-based feedback to enable the user to more deeply understand a problem. As a result, a learner may more effectively understand and solve the problem.

FIG. 4 is a schematic block diagram of an apparatus for providing a conversation-based visual knowledge service using image editing according to another embodiment.

Referring to FIG. 4, the apparatus 100 for providing a conversation-based visual knowledge service using image editing according to another embodiment may include a multimodal large language model 110 and conversation history database 120.

The multimodal large language model 110 receives a user question and a user-provided image, which is an image uploaded by the user to supplement explanation of a problem, and provides textual response output to the user.

Here, the multimodal large language model may be, for example, GPT4-V.

Here, the image may be referenced for generating a textual answer but may not be used for direct image editing.

The textual response output may include the interpretation of a problem or a hint, and may be provided to respond to a question without an image annotation.

That is, in another embodiment illustrated in FIG. 4, only text information is provided to a user as problem-solving guidance, thereby assisting understanding of the problem without visual elements. Particularly, it is designed to improve a learner’s ability to understand and solve a problem through text information in an educational context.

The conversation history database 120 stores conversation records of the user and is used to understand the context of a new question and generate an answer. The conversation history database 120 will be described in detail later with reference to FIG. 6.

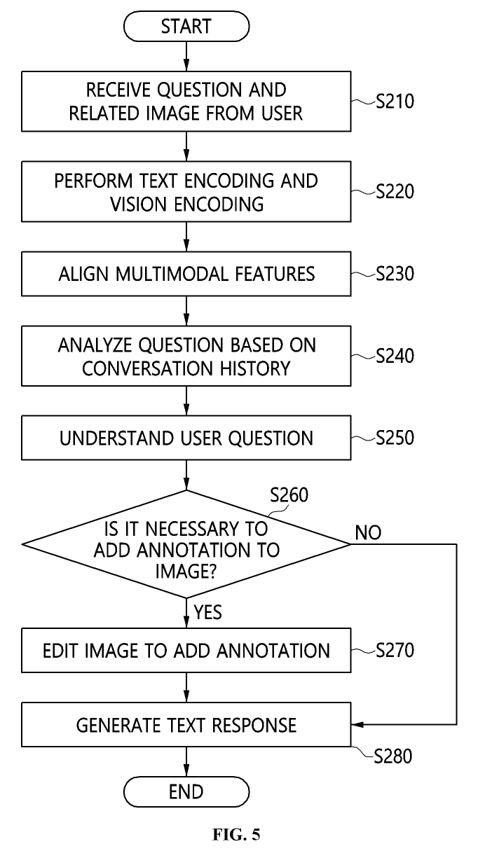

FIG. 5 is a flowchart for explaining a method for providing a conversation-based visual knowledge service using image editing according to an embodiment.

Referring to FIG. 5, the method for providing a conversation-based visual knowledge service using image editing according to an embodiment may include receiving a user question and an image through a user prompt at step S210, understating the context of the question based on a conversation history of the user at steps S220 to S250, and generating a response to the user question by adding an annotation to the input image based on the understood context of the question at steps S260 to S280.

Here, understanding the context of the question at steps S220 to S250 may include encoding and vectorizing each of the user question and the image at step S220, integrating a user question vector and an image vector to align multimodal features representing the relevance between the user question and the image at step S230, and understanding the context of the user question based on the multimodal features and the conversation history with the user at steps S240 to S250.

That is, when a user-provided question and a related image are input at step S210, the apparatus 100 encodes the user question and the related image through a text encoder and a vision encoder, respectively, thereby vectorizing the user question and the related image at step S220.

Subsequently, the apparatus 100 integrates the text vector and the image vector to align the relevance between the user question and the image at step S230.

Accordingly, the apparatus 100 activates a language model based on the integrated multimodal features, thereby understanding the context of the question and generating an appropriate response.

As described above, in an embodiment, a more accurate and detailed response may be provided in response to the question of the user by using multimodal data.

Here, the apparatus 100 performs analysis on a new question from the user based on a previous conversation history stored in the conversation history database 120 at step S240 and understands the question of the user at step S250.

Here, the conversation history may be previously stored in the conversation history database 120 that stores conversation records of the user in chronological order.

Meanwhile, generating the response at steps S260 to S280 may include determining whether it is necessary to add an annotation to the input image based on the understood context of the question at step S260 and performing image editing to add a required annotation to the user image at step S270 when it is necessary to add an annotation to the image.

That is, the apparatus 100 determines whether to add an annotation to the image based on a result of understanding the user’s question at step S260.

When it is determined at step S260 that it is necessary to add an annotation to the image, the apparatus 100 edits the annotated image through the image editor 130 at step S270. Performing the image editing through the image editor 130 at step S270 will be described in detail later with reference to FIGS. 7 and 8.

Subsequently, the apparatus 100 generates a text response at step S280 and provides the text response and the edited annotated image to the user.

FIG. 6 is an exemplary view of conversation history database according to an embodiment.

Referring to FIG. 6, the conversation history database 120 stores all conversation records between a user and a tutor and may comprehensively manage input data including text and images.

In an embodiment, the interaction between the user and the tutor may be stored by utilizing the conversation history database 120, and the context of previous conversations is utilized for a new question, whereby the accuracy and relevance of responses may be improved.

An in/out history (121,122) records user’s questions and tutor’s responses in chronological order, and this is essential for understanding the context of subsequent user questions and generating appropriate responses.

Records of previous conversations between the user and the tutoring system are stored in a previous conversation context 121, in which both images and text are recorded. Also, a question currently input by the user is stored as an input prompt history 122, which may be utilized for inference for generating a conversation and an image annotation for tutoring.

That is, in an embodiment, previous questions of the user and responses of the tutor are integrated to contribute to understanding and processing new questions, thereby maximizing the effectiveness of tutoring.

FIG. 7 is a flowchart for explaining in detail performing image editing according to an embodiment, and FIG. 8 is an internal block diagram of an image editor according to an embodiment.

Referring to FIG. 7, performing image editing according to an embodiment at step S270 may include encoding an image input by a user from a pixel space into a latent vector at step S271, artificially adding noise to the latent vector at step S272, encoding a text annotation based on a conversation history with the user at step S273, generating an annotation while removing the noise from the image at step S274, and decoding the latent vector into an image in the pixel space at step S275.

Here, the image 1 input by the user may be represented in pixel units in the pixel space, as illustrated in FIG. 8.

Accordingly, at step S271, the encoder 131 of the image editor 130 encodes the input image 1 in the pixel space to generate image data in the form of a latent vector for editing (encoding the input image from the pixel space to a latent vector), as illustrated in FIG. 8.

Here, the encoder 131 compresses the image from high-dimensional data to low-dimensional data to prepare for subsequent processing.

Subsequently, at step S272 according to an embodiment, the forward denoising unit 132 of the image editor 130 illustrated in FIG. 8 intentionally adds noise to the image. This is intended to enable a desired annotation to be added later while removing the intentionally added noise.

Meanwhile, at step S273, the text encoder 133 of the image editor 130 illustrated in FIG. 8 utilizes previous conversations between the user and the tutoring system as context and receives a text annotation indicating the annotation to be added.

Accordingly, at step S274, the reverse denoising unit 134 of the image editor 130 illustrated in FIG. 8 processes the data processed by the forward denoising unit 132 in reverse order, thereby removing noise at each step.

Here, the reverse denoising unit 134 is also provided with a text vector encoded by the text encoder 133 and then performs visual annotation generation through image restoration under a condition such that an image suitable for a text request is generated when the noise is removed.

Finally, at step S275, the decoder 135 of the image editor 130 illustrated in FIG. 8 converts the annotated image latent vector back into an image 1′ in the pixel space.

Here, the annotated image 1′ is finally restored by adding a visual annotation 2 to the original image 1.

Accordingly, when performing image editing according to an embodiment at step S270, the image 1 in the pixel space passes through a latent space and is finally generated as an image 1′ to which the annotation 2 is added, as illustrated in FIG. 8.

The annotated image may be used as learning or reference materials and may provide clearer information to the user.

According to the above-described embodiment, accurate annotations are added based on the question of the user and the related image, thereby assisting understanding of a learner in a tutoring process.

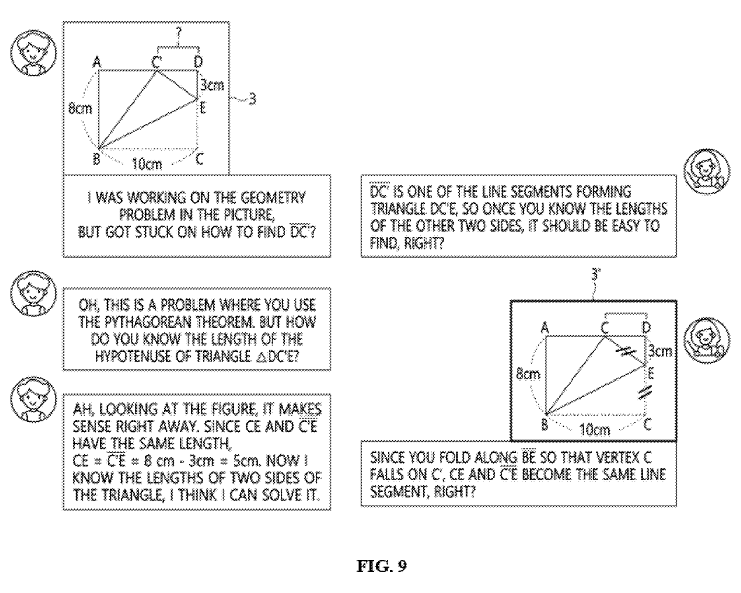

FIG. 9 is an exemplary view illustrating application of an embodiment to the field of mathematics tutoring.

Referring to FIG. 9, when a student inputs a geometry problem and a related geometric figure image 3 as a prompt through the user interface 10, the apparatus 100 provides the user with an annotated image 3′ in which an annotation indicating that the length of CE is equal to the length of EC′ is added to the geometric figure image input by the user, along with the response text.

Accordingly, the student may understand the process of solving the geometry problem more intuitively than when only a response generated in text is provided, whereby learning effectiveness may be improved.

FIG. 10 is a flowchart for explaining a method of training an image editor according to an embodiment.

Referring to FIG. 10, the method of training an image editor according to an embodiment may include initializing a trainable image editor at step S310, editing an image input by a user at steps S320 to S360, and updating the image editor based on a result of evaluation of the edited image at steps S370 to S380.

Steps S320 to S360 correspond to inference during training and may specifically include encoding the image input by the user from a pixel space into a latent vector at step S320, artificially adding noise to the latent vectorat step S330, encoding a text annotation based on a conversation history with the user at step S340, generating an annotation while removing the noise from the image at step S350, and decoding the latent vector into an image in the pixel space at step S360.

Here, steps S320 to S360 are identical to steps S271 to S275 described above, so a detailed description thereof will be omitted.

Also, steps S370 to S380 may include evaluating the accuracy of editing by comparing the edited image with a ground truth image at step S370 and updating the image editing model based on the evaluation result at step S380.

The method of training the image editor 130 is performed to continuously improve the accuracy of annotation generation through image editing. Accordingly, the image editor 130 may be optimized.

According to the above-described embodiment, an accurate annotation is added based on a user’s question and a related image, thereby assisting understanding of a learner in a tutoring process.

FIG. 11 is a view illustrating a computer system configuration according to an embodiment.

At least one of the apparatus 100 for providing a conversation-based visual knowledge service using image editing, or the user interface 10, or a combination thereof according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, it is possible to support professionals in visually and easily explaining information required in their field by immediately modifying or adding graphs, figures, images, and the like according to the requirements of users.

According to the disclosed embodiment, information tailored to the requirements of individual users may be provided by enabling dynamical modification of images and incorporation of additional explanations in response to users’ questions.

According to the disclosed embodiment, the capability to better understand problems or situations presented by learners, patients, and customers and to derive appropriate solutions may be enhanced.

According to the disclosed embodiment, communication and information delivery methods may be significantly improved in various fields such as education, healthcare, and commerce, professional knowledge may be more effectively conveyed, and users’ visual understanding may be maximized.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for providing a conversation-based visual knowledge service using image editing, comprising:
receiving a user question and an image through a user prompt;
understanding context of the question based on a conversation history of the user; and
generating a response to the user question by adding an annotation to the input image based on the understood context of the question.

2. The method of claim 1, wherein understanding the context of the question comprises:
encoding and vectorizing each of the user question and the image;
integrating a user question vector and an image vector to align multimodal features representing relevance between the user question and the image; and
understanding the context of the user question based on the multimodal features and the conversation history with the user.

3. The method of claim 1, wherein the conversation history is previously stored in conversation history database that stores conversation records with the user in chronological order.

4. The method of claim 1, wherein generating the response comprises:
determining whether it is necessary to add an annotation to the input image based on the understood context of the question; and
when it is necessary to add an annotation to the image, performing image editing to add a required annotation to the image.

5. The method of claim 4, wherein performing the image editing comprises:
encoding the image input from the user from a pixel space into a latent vector;
artificially adding noise to the latent vector;
adding the annotation to the image while removing the noise from the image; and
decoding the latent vector into an image in the pixel space.

6. The method of claim 5, wherein:
performing the image editing further comprises encoding a text annotation based on the conversation history with the user, and
adding the annotation comprises adding an annotation corresponding to the text annotation to the image.

7. An apparatus for providing a conversation-based visual knowledge service using image editing, comprising:
memory in which at least one program is recorded; and
a processor for executing the program,
wherein when a user question and an image are input through a user prompt, the program understands context of the question based on a conversation history of the user and generates a response to the user question by adding an annotation to the input image based on the understood context of the question.

8. The apparatus of claim 7, wherein, when understanding the context of the question, the program encodes and vectorizes each of the user question and the image, integrates a user question vector and an image vector to align multimodal features representing relevance between the user question and the image, and understands the context of the user question based on the multimodal features and the conversation history with the user.

9. The apparatus of claim 7, wherein the conversation history is previously stored in conversation history database that stores conversation records with the user in chronological order.

10. The apparatus of claim 7, wherein, when generating the response, the program determines whether it is necessary to add an annotation to the input image based on the understood context of the question; and when it is necessary to add an annotation, the program performs image editing to add a required annotation to the image.

11. The apparatus of claim 10, wherein, when performing the image editing, the program encodes the image input from the user from a pixel space into a latent vector, artificially adds noise to an image vector, generates an annotation while removing the noise from the image, and decodes the latent vector into an image in the pixel space.

12. The apparatus of claim 11, wherein, when performing the image editing, the program encodes a text annotation based on the conversation history with the user and adds an annotation corresponding to the text annotation to the image.

13. A method for providing a conversation-based visual knowledge service using image editing, comprising:
receiving a user question and an image through a user prompt;
understanding context of the question based on a conversation history with the user;
determining whether it is necessary to add an annotation to the input image based on the understood context of the question;
when it is necessary to add an annotation to the image, performing image editing to add a required annotation to the image input by the user; and
generating a response to the user question by including the edited image.

14. The method of claim 13, wherein understanding the context of the question comprises:
encoding and vectorizing each of the user question and the image;
integrating a user question vector and an image vector to align multimodal features representing relevance between the user question and the image; and
understanding the context of the user question based on the multimodal features and the conversation history with the user.

15. The method of claim 13, wherein the conversation history is previously stored in conversation history database that stores conversation records with the user in chronological order.

16. The method of claim 13, wherein performing the image editing comprises:
encoding the image input from the user from a pixel space into a latent vector;
artificially adding noise to the latent vector;
generating an annotation while removing the noise from the image; and
decoding the latent vector into an image in the pixel space.

17. The method of claim 16, wherein:
performing the image editing further comprises encoding a text annotation based on the conversation history with the user, and
adding the annotation comprises adding an annotation corresponding to the text annotation to the image.
